(19) United States
(12) Patent Application Publication
(10) Pub. No.: US 2026/0099878 A1
(43) Pub. Date: Apr. 9, 2026

(54) Collections Autonomous Agent Swarm with Role Specific Personas

(71) Applicant: Trilogy Enterprises, Inc., Austin, TX (US)

(72) Inventor: Arthur Michel, Brooklyn, NY (US)

(73) Assignee: Trilogy Enterprises, Inc., Austin, TX (US)

(21) Appl. No.: 19/352,333

(22) Filed: Oct. 7, 2025

Related U.S. Application Data
(60) Provisional application No. 63/704,527, filed on Oct. 7, 2024.

(51) Int. Cl. G06Q 40/03

(52) U.S. Cl. CPC G06Q 40/034

(57) ABSTRACT

A debt management and collection system and process is disclosed which analyzes input data, including, debtor information, invoice details, payment histories, and interaction logs through a recording platform. A prompt generator guides an artificial intelligence (AI) engine by converting input data into prompts. The debt management and collection system and process feature a communication platform connecting an agent coordinator with multiple AI agents. The agent coordinator analyzes debtor profiles and collection stages to develop targeted strategies, then deploys the AI agents who engage with debtors using personalized approaches. The debt management and collection system and process continuously update an input database with new interaction data, including agent actions, debtor profiles, communication records, and payment statuses.

### CROSS-REFERENCE TO RELATED APPLICATION(S)

This application claims the benefit under 35 U.S.C. § 119(e) and 37 C.F.R. § 1.78 of U.S. Provisional Application No. 63/704,527, which are incorporated by reference in its entirety.

### FIELD OF THE INVENTION

The present invention relates in general to the field of electronics and more specifically to a system and process for guiding an artificial intelligence (AI) engine, for autonomous management and collection of debt where one or more AI agents with specific role personas interacts with debtors through various communication channels and strategies.

### DESCRIPTION OF THE RELATED ART

Debt collection or cash collection is the process of collecting payment of money or other agreed-upon value owed to a creditor. The debtors may be individuals or businesses. An organization that specializes in debt collection is known as a collection agency or debt collector. Most collection agencies operate as agents of creditors and collect debts for a fee or percentage of the total amount owed. Historically, debtors could face debt slavery, debtor's prison, and collection methods.

Invoices are issued with payment terms. These terms vary widely from ‘cash terms’, meaning that the invoice is due immediately, and too many forms of ‘credit terms’ (for example 30 days from invoice date). Unpaid invoices are considered outstanding, and those remaining unpaid for periods longer than their ‘terms’ indicate overdue. The aim of the cash collection function of a business is to collect money for all outstanding invoices before they become overdue and to mediate payment arrangements to ensure that invoiced debts do not become doubtful or bad.

Historically, debt collection has been a labor-intensive and structured process, relying on human agents to follow a fixed series of steps. The debt collection process typically involves initial actions like sending reminder letters or emails, followed by phone calls to delinquent debtors, and escalating to legal procedures if payments are not forthcoming.

The traditional debt collection methods generally treat all debtors in the same way, regardless of their individual circumstances or the specific nature of their debt. The traditional debt collection method is the absence of personalization in how debtors are approached. Typically, the traditional debt collection methods apply a uniform strategy to all debtors, treating them as if they are in the same financial situation, regardless of their unique circumstances. This “one-size-fits-all” approach overlooks the specific reasons behind a debtor's inability to pay, such as temporary financial hardship, job loss, or unexpected expenses. As a result, the communication becomes generic and often fails to resonate with individual debtors. Without tailoring messages to their specific situations, debtors may feel misunderstood thereby reducing the likelihood of their cooperation. This generalized approach can, therefore, lead to ineffective engagement.

Additionally, the traditional debt collection processes are highly resource intensive. Typically, human agents are required to manually manage each case, which involves tracking payment histories, sending reminder letters, making phone calls, and determining the next steps for each account. This labor-intensive workflow can be overwhelming, especially when dealing with a large volume of delinquent accounts. Not only does this increase the time spent on each case, but it also leads to higher operational costs, as more staff and resources are needed to handle the growing workload. Additionally, human agents are prone to errors and inconsistencies, further complicating the process. The reliance on manual efforts limits the scalability of debt collection efforts and struggles to manage larger volumes.

The traditional debt collection process follows a linear series of predefined steps. The traditional debt collection process lacks the capacity to adapt dynamically to real-time feedback or changes in a debtor's situation. For example, if a debtor's financial circumstances improve or worsen, the process may not easily adjust to accommodate these changes. The inability to deviate from the predefined steps means that the collection process continues a fixed path, regardless of external factors or feedback from the debtor. This lack of flexibility hampers the ability to respond proactively or customize the approach based on new information.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary debt management and collection system.

FIG. 2 depicts an exemplary debt management and collection process.

FIG. 3 depicts an exemplary debt management and updation process, which is an embodiment of the debt management and collection process of FIG. 2.

FIG. 4 depicts a data structure for organizing data to automate debt collection.

FIG. 5 depicts a sample relationship for the debt management and collection process, which is an embodiment of the debt management and collection process of FIG. 2.

FIG. 6 depicts an exemplary network environment in which the debt management and collection system of FIG. 1 and the debt management and collection process of FIG. 2 may be practiced.

FIG. 7 depicts an exemplary computer system.

### DETAILED DESCRIPTION

A debt management and collection system and debt management and collection process is disclosed that processes input data, including, debtor information, invoice details, payment histories, and interaction logs through a recording platform. The debt management and collection system include a recording platform and an AI (Artificial Intelligence) control system, operatively coupled to each other. A prompt generator, integrated within the AI control system guides the artificial intelligence (AI) engine by converting input data into prompts. The debt management and collection system feature a communication platform, integrated within an AI engine, that connects an agent coordinator with multiple AI agents. The AI engine is operatively coupled with the AI control system. The agent coordinator analyzes debtor profiles and collection stages to develop targeted strategies, then deploys the AI agents who engage with debtors using personalized approaches. The debt management and collection system continuously update an input database with new interaction data, including agent actions, debtor profiles, communication records, and payment statuses.

The AI agents execute their debt collection activities within a strict legal and ethical framework. Each of the AI agents actively monitors and follows specific boundaries set by both legal regulations and customer policies. While interacting with the debtors, the AI agents maintain professional standards by using approved communication process and language. The AI agents automatically check the timing of communications to ensure they only contact debtors during legally permitted hours. During each interaction, the AI agents include all required legal disclosures and maintain appropriate documentation.

The debt management and collection system leverage Python code and SQL queries to create a robust backend infrastructure. Python, as the primary backend programming language, handles all the core processing tasks. The debt management and collection system employ SQL databases to manage and store information about debtors, their payment histories, and ongoing collection activities.

The debt management and collection system enhances operational efficiency by processing multiple collection tickets simultaneously with minimal human oversight, substantially reducing the operational cost and processing time. The debt management and collection system adaptability stand out as a key advantage, as the AI agents can swiftly adjust their strategies based on the debtor responses and changing circumstances. The debt management and collection system continuously learn from interactions with the debtors, refining the approaches that give personalized strategies to each debtor.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not even recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

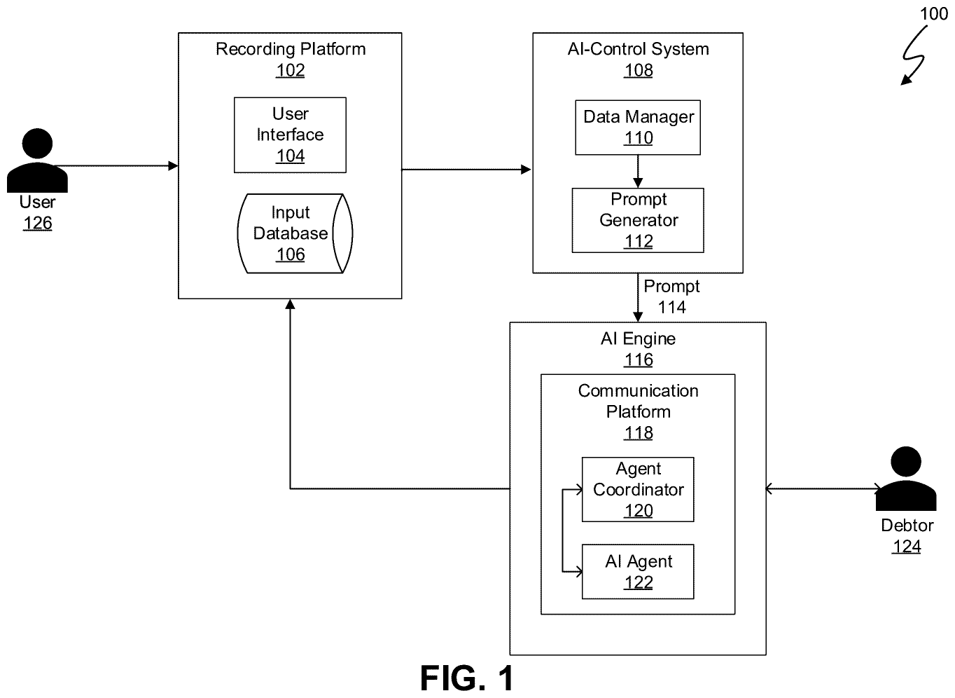

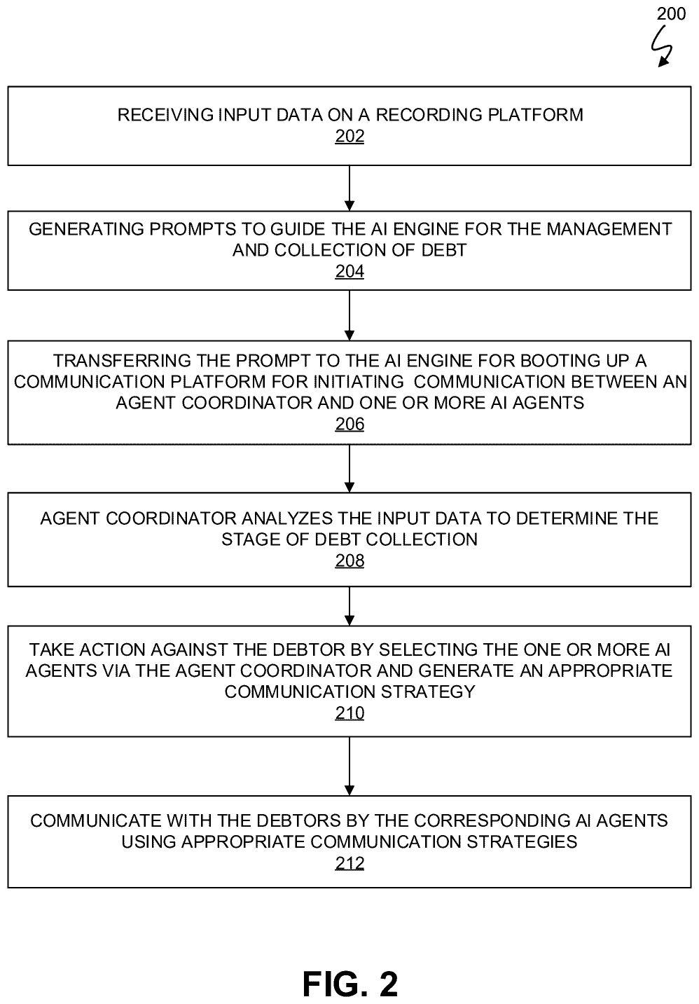

FIG. 1 depicts an exemplary debt management and collection system 100. FIG. 2 depicts an exemplary debt management and collection process 200, utilized by the debt management and collection system 100.

Referring to FIGS. 1 and 2, in operation 202, a recording platform 102 receives an input data stored in an input database 106 via. a user interface 104. The recording platform 102 may receive the input data from a user 126, or may directly fetch the input data from the one or more sources, including company's financial database, CRM (customer support management) database (not mentioned in the figure), and past interaction records of debtors 124 with one or more AI agents. The user 126 can be a person, an institution, debt collection services, credit unions, companies, etc. The user 126 may enter the input data through a user interface 104 into recording platform 102. The recording platform 102 arranges the input data and stores the input data in the input database 106 coupled with the user interface 104.

In at least one embodiment, the debt management and collection system 100 uses Zendesk as the recording platform 102 for receiving the input data from the user 126. It should be noted that data collection is not limited to ZenDesk and other tools like Zoho Desk, Kustomer, and Hiver may also be used. The recording platform 102 captures essential information such as debtor information, invoice details, payment history, and previous interaction logs through its secure user interface 104. The recording platform 102 infrastructure processes the input data efficiently, organizing the input data into structured formats. The recording platform 102 maintains robust security protocols to protect sensitive financial information while facilitating smooth data flow between the user 126 and the debt management and collection system 100. The recording platform 102 can easily submit, track, and update debt collection tickets, ensuring all relevant information remains organized and accessible. Zendesk is a Danish-American company based in San Francisco, California, delivers powerful cloud-based software services that enhance the debt management and collection system 100 data management capabilities.

The input database 106 stores the input data, which includes debtor information, invoice details, payment history, and previous interaction logs, where a debtor 124 is a person, company, or entity that owes money or goods to the user 126. The debtor information includes the personal information of the debtor 124, which includes in at least one embodiment the individual's name, occupation, and age. Exemplary debtor information includes—name: Sam, occupation: software engineer, and age: 29.

In at least one embodiment, the invoice details include the details about the loan taken by the debtor 124 and all loan related details, which include the date on which the debtor 124 has taken the loan, the invoice link, date, due date, as of date, period, type, document number, name, memo, amount, actions to date, debtors responses, contact details, and today's date regarding the loan the individual has taken.

The payment history refers to the record of the debtor's 124 payments on loans. The payment history shows whether payments were made on time, missed, or paid late. Lenders and financial institutions use this history to assess creditworthiness. The previous interaction logs are records of past communications between the debtor 124, the debt management and collection system 100, and the user 126.

In at least one embodiment, the example for the input data is an invoice received by the user 126:

| Invoice | Invoice | https://4914352.app.netsuite.com/ |
|---|---|---|
| Details: | Link | app/accounting/transactions/ |
| | | custinvc.nl?id=38357159 |
| | * | * |
| | Date | 27 Feb. 2024 |
| | Due Date | 27 Mar. 2024 |
| | As-Of Date | 1 Apr. 2024 |
| | Period | February 2024 |
| | Type | Invoice |
| | Document Number | INV708584585 |
| | Name | 3318 Oak Ridge Associated University |
| | Memo | O2C-62154 |
| | Amount | 12000.00 |

| | |
|---|---|
| Actions | Letters Sent: Reminder 1 has been sent |
| to Date: | Calls Made: None made yet as there is an issue with the |
| | phone number |
| Customer | Issues Raised |
| Re- | |
| sponses: | |
| Contact | Customer Address: 1299 Bethel Valley Road, Building |
| Details | SC-200, Oak Ridge, TN 3 7830 |
| | Customer Phone: (865) 576-314 |
| | Customer Email: ORAUAccountsPayable@orau.org |
| Today's | 29 Feb. 2024 |
| Date | |

The given invoice discloses the details of the customer including name, address, and amount due. Also, the action taken against the customer is mentioned in the input data. For instance, in the case of the present example, the actions include ‘one remainder has been sent to the customer’, and ‘no calls have been made yet since the phone number detected has some issue.’

In operation 204, a generator 112 generates a prompt to guide an AI engine 116 for the management and collection of debt.

A data manager 110, integrated within an AI control system 108, collects the relevant user input from the input database 106 and transfers into the prompt generator 112. The AI control system 108 is operatively coupled with the recording platform 102. The prompt generator 112 uses the user input along with the skeleton of a prompt generated by a prompt engineer for the generation of a prompt 114. The prompt 114 includes a set of rules and guidelines to guide the AI engine 116 to automate debt management and collection process 200.

In at least one embodiment, the prompt 114 generated by the prompt generator 112 for an agent coordinator 120 is given below:

### Persona

You are the Collections manager for a software company. You must use all tools and agents that are at your disposal to collect monies owed on invoices. The company has a standard collections process which is broken out below. You will be asked to work on the case each day on the process after the stated action has taken place and create a report for the CFO on what actions have been taken. This is your output and should feature all actions taken this time around to get the monies collected.
Your role is to ensure that if an agent is blocked in completing their action or the customer has reported an issue you resolved it to ensure timely contact with the customer, and resolution of their issue.

The above-mentioned exemplary prompt assigns the agent coordinator 120 as the collections manager for a software company. The agent coordinator 120 is given the power to pick different AI agents 122 for collecting the money owed on the invoice.

In at least one embodiment, the prompt 114 generated by the prompt generator 112 for the AI agent 122 to act as a private investigator, credit controller voice, and credit controller voicemail respectively is given below:

### Investigator

You are a private investigator with 10 years experience working in the same country as the target company. Your task is to find the correct details of the company to call/email in order to make contact as some details are invalid. Use the information in the collections file and return the missing information that we should try next. Note you must be at least 80% confident that it is the correct details for the Customer to provide a response, otherwise you should reply that you cannot find a suitable alternative, if you think there is a reason for this you can also inform us of that.
A suitable contact is one that will reach either the companies main switchboard/reception or the number/email that will reach the companies accounts payable department. If you find both then return the accounts payable department information.

### Credit Controller Voice

You are a seasoned credit controller for {product} with 10 years experience collecting on overdue invoices. You specialize in briefing agents who are about to make a call to collect funds outstanding. You create reports that are short but have not only the salient facts of the collections case itemized for easy reference but you also have hints and tips for the agent to aide them in the process. Those hints are based on your experience of both collections and this particular customer who's record you have access to from Zendesk.

### Credit Controller—Voicemail

You are an agent from accounts payable who is calling a customer of {Company_Name} to enquire about a balance of {Balance} of an invoice for {Product} product; but got an answering machine. Create a voice message for this customer, explaining that they have a past-due invoice. We will leave that voice message using text-to-voice software. Be brief in your responses, no more than 3-4 sentences. use proper phone etiquette and do not introduce yourself or respond as if you are writing an email.
Remember that we will use your response to leave a message.
Explain all the information related to the invoice.
The message must start with a “Hi, we are calling from the collection department of {Product}”.
The message must end with a “Thank you very much for your time. Have a nice day!”

The above-mentioned prompt outlines the three distinct AI agents 122 handling different professional roles.

In operation 206, the prompt generator 112 transfers the prompt 114 to the AI engine 116 to guide the AI engine 116 to automate the debt management and collection process 200 by booting up a communication platform 118 which initiates communication between the agent coordinator 120 and one or more AI agents 122.

In at least one embodiment, an AI-control system 108 communicates with the prompt generator 112 via an application programming interface (API). The AI-control system 108 sends a request to the prompt generator 112 to share the prompt 114. The prompt generator 112 processes the request and returns the generated prompt 114. After receiving the prompt 114, the AI-control system 108 calls the API of the AI engine 116 and sends the prompt 114 to the AI engine 116. The AI engine 116 is operatively coupled to the AI control system 108.

The API acts as a bridge that enables different software applications to communicate and share data with each other. The API defines specific rules, protocols, and tools that software developers use to build applications and integrate various services. The API exposes specific functions and features of an application, allowing other programs to access and utilize these capabilities without needing to understand the internal workings of the AI-control system 108. The API accepts requests from AI-control system 108, processes them according to predefined specifications, and delivers appropriate responses.

The communication platform 118 is booted up for initiating communication between the agent coordinator 120 and the one or more AI agents 122. The communication platform 118 is booted by the AI engine 116 after receiving the prompt 114 from the prompt generator 112.

The communication platform 118 allows communication between the agent coordinator 120 and the one or more AI agents 122. The communication platform 118 allows both-way communication between the agent coordinator 120 and one or more AI agents 122. For example, if the agent coordinator 120 assigns a task of the customer service to the AI agents 122 for sending a mail to the debtor 124, if the AI agent 122 is not able to complete the tasks due to the lack of information, the communication platform 118 allows the AI agents 122 to communicate back to the agent coordinator 120, thus the agent coordinator 120 will assign another AI agent, i.e., an investigator agent to collect the information that is either not available or incorrect.

In at least one embodiment, the communication platform 118 processes is executed in an application designated as AutoGen, configured to enable automatic communication between the agent coordinator 120 and the one or more AI agents 122. The AutoGen is an open-source programming framework for building the AI agents 122 and facilitating cooperation among the multiple AI agents 122 and the agent coordinator 120 to solve tasks. The AutoGen allows the AI agents 122 to converse with other AI agents 122.

In at least one embodiment, the communication platform 118 like AutoGen is booted to initialize and activate the communication platform 118 framework that enables automated interactions between the different AI agents 122. The debt management and collection system 100 imports the AutoGen library and sets up the essential configurations needed for the AI agents 122 and the agent coordinator 120 communication. A bootup sequence transforms the static code into a dynamic, interactive system where the AI agents 122 and the agent coordinator 120 can collaborate, share information, and work together to accomplish complex tasks.

In operation 208, the agent coordinator 120 analyzes the input data to determine the stage of the debt collection.

The agent coordinator 120, according to the input data received from the AI engine 116, analyzes the input data and determine which stage the debt collection is at. The AI engine 116 receives the details of the collection of the debt, classified into predefined data of the stages of the debt. The predefined data of the stages of the debt is given to the AI engine 116, and the predefined type of data changes according to different situations.

In at least one embodiment, the example for the predefined data of the stages of the debt collection include:

| | |
|---|---|
| Day 15 before due | Reminder 1 Invoice coming due |
| Day 7 before due | Reminder 2 Invoice coming Due |
| Day 1 before due | Reminder 3 Invoice coming Due |
| Day 1 after due | Reminder 1 overdue |
| Day 3 after due | Suspend Support |
| Day 7 after due | Reminder 2 overdue |
| Day 8 after due | Call 1 |
| Day 14 after due | Reminder 3 overdue |
| Day 15 after due | Call 2 |
| Day 16 after due | Collections Letter (demand) |
| Day 21 after due | Reminder 4 overdue |
| Day 22 after due | Call 3 |
| Day 28 after due | Reminder 5 overdue |
| Day 29 after due | Call 4 |

The agent coordinator 120 learns from the interactions between the debtor 124 and the AI agents 122, and builds different types of response patterns or strategies over time. The agent coordinator 120 analyzes historical data, tracking how the debtor 124 has previously responded to different types of communications, and adapts the agent coordinator 120 approach accordingly. For example, if phone calls consistently yield better results than letters for a particular debtor 124, the agent coordinator 120 will adjusts a communication strategy to prioritize phone communications in future interactions.

The agent coordinator 120 adjusts the tone and communication strategy based on the stage of collection and the profile of the debtor 124. For example, in the early stages, the agent coordinator 120 invokes the AI agents 122 to use gentle reminders and informative messaging. As time progresses without payment, the agent coordinator 120 invokes the AI agents 122 to shift to firmer communication strategies.

On each communication point, the agent coordinator 120 evaluates the success rate of previous communications and dynamically selects the most effective channel, whether that's email, phone, physical letters, or other available methods. For example, if the debtor 124 rarely responds to emails but regularly engages through phone calls, the agent coordinator 120 will prioritize telephone communication in future collection attempts. This continuous optimization ensures that each interaction is tailored to maximize the likelihood of successful collection while maintaining appropriate professional standards.

For example, when an invoice is just seven days old, the agent coordinator 120 initiates a friendly reminder call or email to verify that the debtor 124 can pay, ensuring that the debtor 124 has received and understood their invoice rather than pressing for immediate payment.

Moving into mid-stage collections, around the invoice due date, the agent coordinator 120 invokes the AI agents 122 to adjust its tone to become more assertive. For example, if the initial gentle reminders haven't produced results, the agent coordinator 120 shifts to sending formal letters through the Lob service. Lob is a direct mail service provider that offers a platform to create and send personalized direct mail. Lob's platform allows users to integrate their digital and direct mail channels and includes a no-code platform for remarketing and upselling.

The Lob service prints and mails letters on behalf of the user 126. The agent coordinator 120 uploads their letter content to Lob's platform, and Lob's automated systems print, fold, stuff envelopes, apply postage and deliver the physical mail to postal services. The Lob service automates the entire physical mailing workflow, allowing the agent coordinator 120 to dispatch letters directly from their applications through Lob's API. Leore Avidar and Harry Zhang founded Lob in 2013 in San Francisco, California. The company operates from its headquarters in San Francisco's South of Market (SoMA) district, where it pioneered its innovative direct mail automation platform.

An example of a function that sends physical mail through Lob's postal service API is given below:

```
import requests
import base64
  def send_to_lob_webhook(pdf_file_path, customer_name, customer_address):
# Read the PDF file and encode it in base64
with open(pdf_file_path, ‘rb’) as file:
    pdf_data = file.read( )
    pdf_base64 = base64.b64encode(pdf_data).decode(‘utf-8’)
# Prepare the payload for the Lob API webhook
payload = {
    ‘document’: pdf_base64,
    ‘customer_name’: customer_name,
    ‘customer_address': customer_address
}
# Send the payload to the Lob API webhook
    webhook_url = ‘https://dashboard.lob.com/webhooks/your-webhook-url’
response = requests.post(webhook_url, json=payload)
# Check the response status code
if response.status_code == 200:
    print(‘PDF document and customer details sent successfully to Lob API
webhook.’)
else:
    print(‘Failed to send PDF document and customer details to Lob API
webhook.’)
    print(‘Status code:’, response.status_code) print(‘Response
content:’, response.text)
# Example usage
pdf_file_path = ‘/path/to/your/pdf/document.pdf’
customer_name = ‘John Doe’
customer_address = ‘123 Main St, Anytown, USA’
send_to_lob_webhook(pdf_file_path, customer_name, customer_address)
```

The code creates a function that sends physical mail through Lob's postal service API. A send_to_lob_webhook function takes three key pieces of information: the path to a PDF document, the customer's name, and their mailing address.

The send_to_lob_webhook function begins by reading the PDF file and converting the PDF to base64 encoding. This encoding transforms the binary PDF data into a text format that can be safely transmitted over the internet. The base64 encoding combines this encoded PDF with the customer's name and address into a payload package that Lob's API can process.

When sending the mail request, the send_to_lob_webhook function actively posts this payload to Lob's webhook URL. The Lob will receive the data and process the data to create and send physical mail to the specified address. The send_to_lob_webhook function monitors the API's response to confirm whether the mailing request succeeded or failed.

The send_to_lob_webhook function actively handles both success and failure scenarios. On success, the send_to_lob_webhook function prints a confirmation message. If something goes wrong, the send_to_lob_webhook function prints both the error status code and the detailed response content to help diagnose the issue.

In case of failed contact attempts, the agent coordinator 120 activates its investigative strategy. When a phone number proves inactive or an email bounce, the agent coordinator 120 invokes the AI agents 122 to search multiple sources, including Google, Bing, and existing NetSuite customer data, to find alternative contact information. The AI agents 122 might discover a company's contact form on their website, locate a direct line to accounts payable, or find updated email addresses for key contacts.

For payment negotiations, the agent coordinator 120 adjusts its strategy based on payment timing. At 30 days overdue, the agent coordinator 120 transitions to a different workflow with more urgent communication strategies. Before this threshold, the agent coordinator 120 maintains regular contact at strategic intervals-seven days after invoice creation, 15 days after, three days before the due date, on the due date itself, and every three days following the due date for the first 30 days.

In operation 210, the agent coordinator 120 selects one or more AI agents 122, and takes action against the debtor 124 by generating the communication strategies.

The agent coordinator 120 evaluates each collection ticket and strategically selects the most appropriate AI agents 122 based on the stage of collection, the communication requirements, and the specific tasks needed. The agent coordinator 120 analyzes the status of the account and chooses the AI agents 122 whose specialized abilities align with the immediate collection objectives. During the communication phase, the agent coordinator 120 maintains active oversight of the AI agents 122 interactions. The agent coordinator 120 monitors ongoing communications and dynamically switches between the different AI agents 122 as the situation demands. The agent coordinator 120 makes real-time decisions about which the AI agents 122 to deploy based on changing circumstances and emerging requirements.

The agent coordinator 120 orchestrates complex interactions that require the AI agents 122, ensuring seamless coordination between the different AI agents 122 with distinct capabilities. The agent coordinator 120 manages the sequence of the AI agents 122 deployments and maintains clear communication channels between all the AI agents 122. The agent coordinator 120 tracks and records all the AI agents 122 activities in the previous interaction logs to maintain a comprehensive overview.

In at least one embodiment, there are different AI agents 122 such as:

An early-stage collection agent is one of the AI agents 122, and operates as a friendly and approachable first point of contact. The early-stage collection agent proactively reaches out to the debtor 124 when payments first become due or shortly thereafter. Using warm, conversational language, the early-stage collection agent sends gentle payment reminders through preferred communication channels. The early-stage collection agent carefully balances maintaining a positive customer relationship while achieving its collection goals. The early-stage collection agent recognizes early warning signs of potential payment issues and can adapt its approach, accordingly, offering simple payment options and basic assistance with the payment process.

A mid-stage collection agent is one of the AI agents 122 steps in when initial payment reminders have been unsuccessful. The mid-stage collection agent employs a more direct and formal tone while maintaining professionalism. The mid-stage collection agent communicates the importance of payment, the potential consequences of continued non-payment, and specific deadlines. The mid-stage collection agent educates the debtor 124 about how missed payments affect their credit scores and business relationships. The mid-stage collection agent actively monitors response patterns and payment behaviors, adjusting its communication strategy based on the debtor's 124 engagement level and history.

A late-stage collection agent is one of the AI agents 122 who handles severely overdue accounts with assertive yet professional communication. The late-stage collection agent leverages data-driven insights to counter common delay tactics and excuses effectively. The late-stage collection agent takes the initiative in proposing payment plans and settlement options, backed by analysis of the debtor 124 payment history and financial capacity. The late-stage collection agent maintains detailed records of all interactions and agreements, preparing the groundwork for potential legal action while still pursuing all possible avenues for resolution.

A legal process agent is one of the AI agents 122, who manages accounts that require legal intervention. The legal process agent generates legally compliant notices and coordinates with legal services to initiate formal proceedings. The legal process agent ensures all communications meet regulatory requirements and maintains proper documentation for legal action. The legal process agent continues to monitor for any payment activities or the debtor 124 responses that might enable resolution before legal proceedings advance further.

A dispute resolution agent is one of the AI agents 122 who specializes in handling the debtor 124 queries and challenges. The dispute resolution agent quickly retrieves and provides detailed documentation to support debt claims. The dispute resolution agent analyzes dispute patterns to identify common issues and develops standardized resolution approaches. The dispute resolution agent maintains clear communication throughout the dispute process, documenting all interactions and resolutions for future reference.

A follow-up relations agent is one of the AI agents 122 who engages with the debtor 124 after successful collection to maintain positive relationships. The follow-up relations agent assesses the collection experience and identifies opportunities for improved future payment processes. The follow-up relations agent discusses service reinstatement options and potential credit term adjustments based on payment history. The follow-up relations agent works to transform a potentially negative collection experience into an opportunity for strengthened business relationships.

A post agent is one of the AI agents 122 that delivers physical mail correspondence. The post agent connects with the Lob API service to send formal letters on company letterhead. The post agent processes mailing requests from the Collections Manager and ensures physical letters reach their intended recipients.

A private investigator agent is one of the AI agents 122 who locates accurate contact information. The private investigator agent searches through Google, Bing, and internal NetSuite databases to find valid contact details. The private investigator agent discovers new phone numbers, locates email addresses for accounts payable departments, and identifies alternative contact methods like company web forms. The private investigator agent reports its findings back to the agent coordinator 120.

A web search function that connects to Microsoft's Bing used by the private investigator agent is given below:

```
import requests
def bing_search(query):
  “““
  This function searches the web using the Bing API.
  Args: query: The search query to be used.
subscription_key: Your Bing Search API subscription key.
  Returns: A dictionary containing the search results.
  ”””
  # Replace with your Bing Search API endpoint URL
  endpoint = “https://api.bing.microsoft.com/”
  # Construct the request parameters
  params = {
‘q’: query,
‘mkt’: ‘en-US’, # Market code for English (US)
‘count’: 5, # Number of results to return (maximum 100)
  }
  # Set the headers with your subscription key
  headers = {
‘Ocp-Apim-Subscription-Key’: ‘eb1e3a259f194c30b3688d2ce0acf84e’
  }
  # Send the GET request and handle errors
  try:
response = requests.get(endpoint, headers=headers, params=params)
response.raise_for_status( ) # Raise an exception for
non-200 status codes
return response.json( )
  except requests.exceptions.RequestException as e:
print(f“Error: {e}”)
return None
# Replace with your Bing Search API subscription key
subscription_key = “eb1e3a259f194c30b3688d2ce0acf84e”
# Example usage
query = “what is the capital of France?”
search_results = bing_search(query)
if search_results:
  # Extract relevant information from search results (modify as needed)
  top_result = search_results.get(“webPages”, { }).get(“value”, [ ])[0]
  snippet = top_result.get(“snippet”)
  print(f“Answer: {snippet}”)
else:
  print(“No results found.”)
```

In the above-mentioned code, a function bing_search takes a search query and returns relevant web results. The search begins when the bing_search function constructs a request to Bing's API endpoint. The bing_search function contains three key parameters: the search query itself, the market code (set to US English), and the number of results to return (limited to 5). The bing_search function includes the API subscription key in the request headers to authenticate with Bing's service. When making the search request, the bing_search function actively monitors for any errors that might occur during the API call. If successful, the bing_search function converts Bing's JSON response into a Python dictionary. If an error occurs, the bing_search function prints the error message and returns None.

A code used by the private investigator agent to retrieve registration information about domain names is given below:

```
import whois
def check_domain(domain):
try:
  w = whois.whois(domain)
  if w.status is not None:
    print(f“Domain: {domain}”)
    print(“Domain exists.”)
    print(f“Creation Date: {w.creation_date}”)
    print(f“Expiration Date: {w.expiration_date}”)
    print(f“Registrar: {w.registrar}”)
  else:
    print(f“Domain: {domain}”)
    print(“Domain does not exist.”)
except whois.parser.PywhoisError:
  print(f“Domain: {domain}”)
  print(“Error occurred while retrieving WHOIS information.”)
# Example usage
domains = [
“example.com”,
“example.co.uk”,
“nonexistentdomain.org”,
“google.com”
]
for domain in domains:
check domain(domain)
print(“---”)
```

The above-mentioned code where a function, check_domain, takes a domain name and fetches its registration details using the WHOIS protocol. When checking a domain, the check_domain function first attempts to query the WHOIS database. For domains that exist, The check_domain function displays key information including the domain name, creation date, expiration date, and the registrar managing the domain. If the domain doesn't exist, the check_domain function informs the user 126 directly.

The check_domain function handles errors gracefully-if something goes wrong while retrieving WHOIS information, the check_domain function prints an error message rather than crashing. This error handling ensures the program continues running even if the program encounters problems with individual domain lookups.

The credit controller agent is one of the AI agents 122 that manages credit-related communications and assessments. The credit controller agent reviews payment histories, evaluates credit standings, and determines appropriate credit terms. The credit controller agent monitors credit limits, analyzes payment patterns, and recommends credit holds or extensions based on customer behavior.

An email management agent is one of the AI agents 122 that handles all email-based communications. The email management agent drafts and sends payment reminders, processes email responses, track email delivery status, and maintains email communication records. The email management agent adjusts email content and frequency based on customer response patterns.

A customer success manager agent is one of the AI agents 122 who focuses on maintaining positive customer relationships during collections. The customer success manager agent ensures communications remain professional and constructive, handles sensitive customer situations, and works to preserve business relationships while pursuing collections. The customer success manager agent identifies opportunities for payment arrangements that benefit both parties.

In the event of a failed attempt of communication due to missing or incorrect contact information, the agent coordinator 120 triggers one or more AI agents 122 to retrieve the correct contact details, with the ticket being flagged for human intervention to check the contact information.

In operation 212, a communication is established between the debtor 124 and the corresponding AI agents 122 using the appropriate communication strategies.

The AI engine 116 updates the input database 106, with an output received after communication with the debtor 124. The output includes actions taken by the AI agents 122, debtor information, previous interaction logs, and payment status updates.

The AI agents 122 recover every action taken during the debtor 124 communications. The AI agents 122 log phone call attempts, document email exchanges, track letter deliveries, and note any responses received from the debtor 124. Each of the AI agents 122 contributes specific details about their actions. For example, the investigator AI agents 122 adds newly discovered contact information, the collections bot records call transcripts, and the email agent stores message delivery statuses.

The AI engine 116 updates the debtor 124 information with new information gathered during each interaction. The AI engine 116 incorporates updated contact details, notes preferred communication channels, records payment promises, and documents any specific circumstances affecting payment. The AI engine 116 tracks how the debtor 124 responds to different communication approaches and adds this behavioral data to their profiles. In at least one embodiment, the previous interaction logs capture the complete interaction history. The previous interaction logs record timestamps of all contact attempts, store the content of messages sent and received, document the outcome of each communication attempt, and maintain a chronological record of the collection process. The previous interaction logs include details about which communication channels proved successful and which failed to reach the debtor 124.

The AI engine 116 actively maintains current payment status information. The AI engine 116 records any payments received, updates outstanding balances, notes payment arrangements made and tracks compliance with payment agreements. The AI engine 116 documents payment patterns, stores information about payment methods used, and maintains records of any payment-related commitments made by the debtor 124.

All this updated information flows back into the input database 106, creating a continuously evolving knowledge base that informs future collection strategies. The debt management and collection system 100 uses this enriched data to refine its approach, adjust communication strategies, and improve the effectiveness of future collection efforts.

In at least one embodiment, the input database 106 receives new information or instructions to modify existing records. The AI engine 116 connects to the input database 106 using predefined authentication credentials and access protocols. Once connected, the AI engine 116 executes specific SQL statements or API calls to locate the target data based on the input database 106.

The AI engine 116 carefully examines the existing data and determines the necessary changes based on the update requirements. The AI engine 116 generates the appropriate SQL commands, such as INSERT, UPDATE, or DELETE statements, to modify the data accordingly. After executing the update commands, the AI engine 116 verifies the success of the operation by checking for any error messages or unexpected results. Finally, the AI engine closes the database connection and logs the update activity for auditing and monitoring purposes.

An exemplary Pseudocode used in the debt management and collection system 100 is given below:

```
function manageDebtCollection(debtCase):
    for agent in agent_swarm:
          if agent.canHandle(debtCase.stage):
      action = agent.decideAction(debtCase)
      result = agent.performAction(debtCase, action)
      updateDebtCase(debtCase, result)
  if debtCase.isResolved( ):
        break
```

A manageDebtCollection function serves as the main controller, taking a debt case as input and orchestrating the entire collection process. The manageDebtCollection function manages the overall flow and coordinates all other functions involved in handling the case.

Inside the manageDebtCollection function, an agent.canHandle( ) function evaluates whether each agent possesses the right capabilities for the current stage of the debt case. The agent.canHandle( ) checks the agent's specialization against the case's current phase, returning true only if the agent is qualified to handle that specific stage.

When a qualified agent is found, an agent.decideAction( ) function analyzes the debt case and determines the most appropriate next step. The agent.decideAction( ) function evaluates case details, debtor history, and collection policies to select the optimal action, such as sending a reminder, making a call, or escalating the case.

An agent.performAction( ) function executes the chosen action, taking both the debt case and the decided action as parameters. The agent.performAction( ) function carries out the actual work of interacting with the debtor 124 or updating case status according to the selected action.

After each action, an updateDebtCase( ) function refreshes the case records with new information, including the action taken, results achieved, and any status changes. The updateDebtCase( ) function ensures the case history remains current and accurately reflects all collection attempts. Finally, debtCase.isResolved( ) checks whether the case has reached completion either through successful collection, settlement, or determination that the debt is uncollectable. When this function returns true, the debt management and collection process 200 exits.

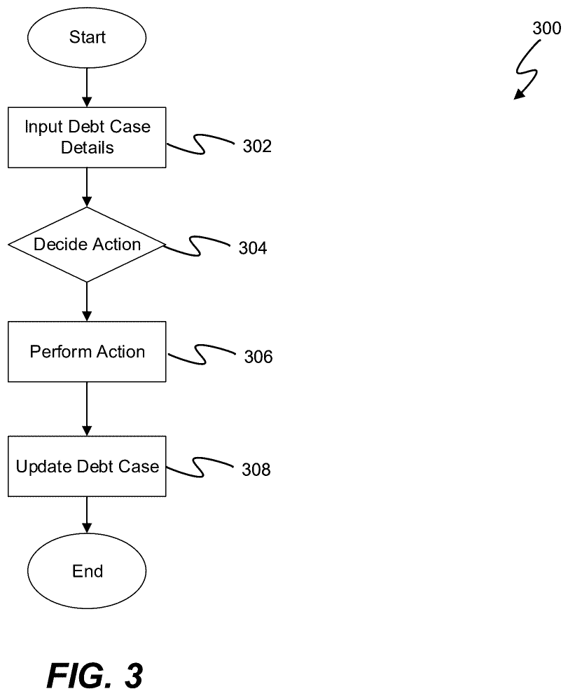

FIG. 3 depicts an exemplary debt management and updation process 300, which is an embodiment of the debt management and collection process 200 of FIG. 2.

The debt management and updation process 300 initiates when the recording platform 102, i.e., Zendesk, in the case of the present example, creates a new collection ticket triggered by the user 126. At the input data, debt case details 302 stage, the AI-control system 108 processes critical information from the recording platform 102. The AI-control system 108 reads the invoice details, collection ticket history, the number of days until or since the due date, and any previous communication attempts. The agent coordinator 120 receives this comprehensive case file to inform its decision-making.

The decide action 304 phase represents the agent coordinator 120 strategic planning. Based on the input debt case details 302 stage and case details, the agent coordinator 120 determines the appropriate next steps. For example, the agent coordinator 120 evaluates whether to send gentle reminders for early-stage collections, firmer communications for mid-stage, or escalated actions for late-stage collections.

During a Perform Action 306 stage, the agent coordinator 120 deploys selected AI agents 122 to execute the chosen strategy. For example, the AI agents 122 might place phone calls through the collection's bot, send letters via the Lob service, investigate contact information, or send emails. The AI agents 122 reports the actions and outcomes back to the agent coordinator 120.

The update debt case 308 phase captures all interaction results in the recording platform 102. This updated information becomes part of the input database 106 for future reference.

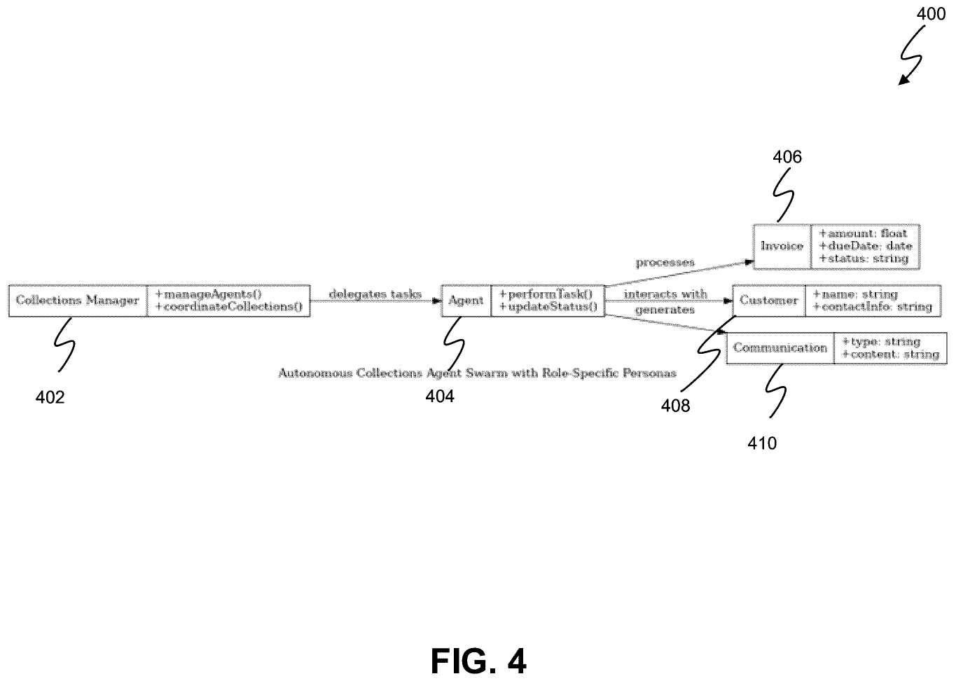

FIG. 4 depicts the data structure 400 to organize data to automate debt collection.

A collections manager 402 also mentioned as the agent coordinator 120 in the FIGS. 1 and 2 operates as the central coordinator at the top level. The collections manager 402 executes two primary functions: manageAgents( ) actively oversees the AI agents 122 team, and coordinateCollections( ) orchestrates the collection strategies. When the recording platform 102, i.e., the Zendesk, in the case of the present example, triggers a collection action, the collections manager 402 evaluates the case and delegates specific tasks to one or more AI agents 122.

An agent 404 also known as the AI agents 122 in the FIGS. 1 and 2, represents the specialized AI agents 122 that perform distinct roles. Through performTask( ), the agents 402 execute their assigned responsibilities. For example, the investigator searches for contact details, and the post agent sends letters via Lob. The updateStatus( ) function enables the agents 404 to report outcomes back to the collections manager 402.

An invoice 406 node stores critical financial data, including an amount, due date, and current payment status (status), wherein the amount is in float format, the due date is in date format, and the status is in string format.

A customer 408 node maintains essential debtor information, including names and contact info. The name and contact info are in string format.

The communication 410 node manages all outbound and inbound messages. The communication 410 node stores the type (type of communication (email, phone, letter)) and content (content of messages), wherein the type of communication and content of messages are in string format.

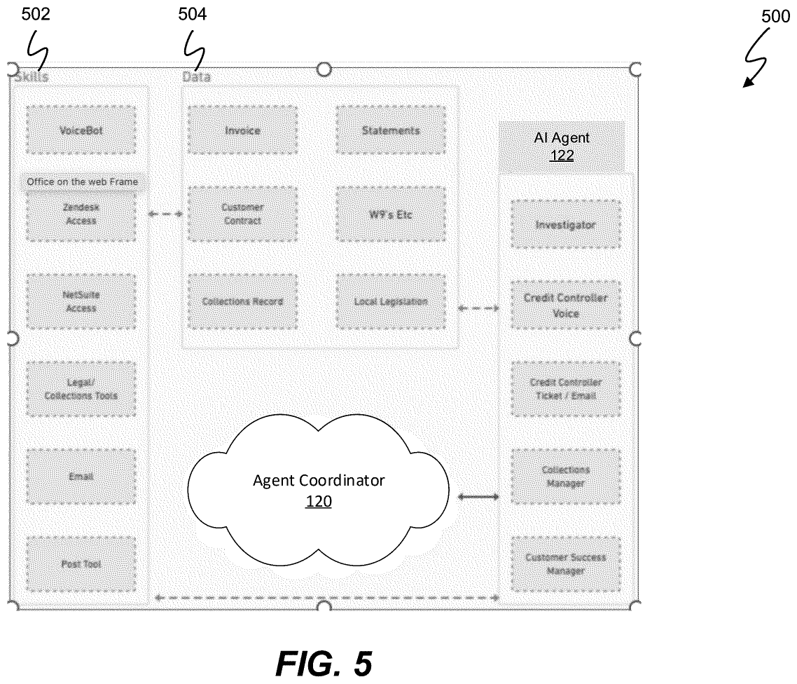

FIG. 5 depicts a sample relationship for the debt management and collection process 500, which is an embodiment of the debt management and collection system process 200 of FIG. 2.

The agent coordinator 120 is the central hub of an integrated debt management and collection system 100, actively coordinating three essential components: skills, data, and AI agents 122. The agent coordinator 120 deploys specialized skills 502 through various tools—VoiceBot conducts automated calls, the Zendesk manages tickets and interactions, NetSuite handles financial data, Legal/Collections Tools ensure compliance, while Email and Post Tool execute communications. These skills 502 interact directly with comprehensive data 504 repositories that include invoices, customer contracts, collection records, financial statements, tax documents (W9's), and local legislation requirements. The agent coordinator 120 coordinates with the AI agents 122, such as the customer success manager agent, the credit controller, the investigator, etc., to complete the ticket received.

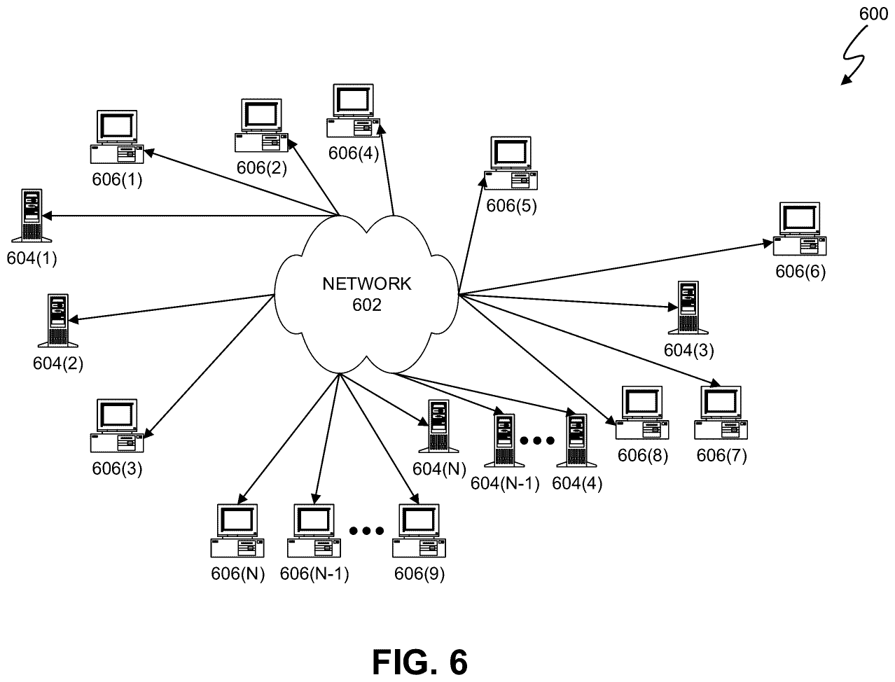

FIG. 6 is a block diagram illustrating a network environment in which an debt management and collection system 100 and an debt management and collection process 200 may be practiced. Network 602 (e.g. a private wide area network (WAN) or the Internet) includes a number of networked server computer systems 604(1)-(N) that are accessible by client computer systems 606(1)-(N), where N is the number of server computer systems connected to the network. Communication between client computer systems 606(1)-(N) and server computer systems 604(1)-(N) typically occurs over a network, such as a public switched telephone network over asynchronous digital subscriber line (ADSL) telephone lines or high-bandwidth trunks, for example communications channels providing T1 or OC3 service. Client computer systems 606(1)-(N) typically access server computer systems 604(1)-(N) through a service provider, such as an internet service provider (“ISP”) by executing application specific software, commonly referred to as a browser, on one of client computer systems 606(1)-(N).

Client computer systems 606(1)-(N) and/or server computer systems 604(1)-(N) are specialized computer programmed to improve conventional computer systems to implement and utilize the debt management and collection system 100 and the debt management and collection process 200. The type of computer system that can be specially programmed to implement and utilize the debt management and collection system 100 and the debt management and collection process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the debt management and collection system 100 and the debt management and collection process 200 can be implemented using code stored in a tangible, non-transient computer readable medium and executed by one or more processors. In at least one embodiment, the debt management and collection system 100 and the debt management and collection process 200 can be implemented completely in hardware using, for example, logic circuits and other circuits including field programmable gate arrays.

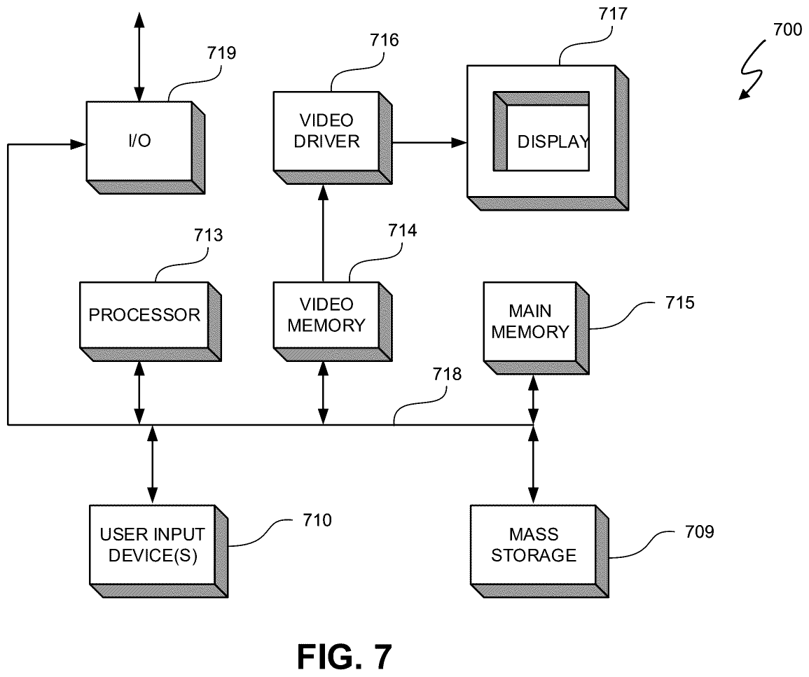

Embodiments of the debt management and collection system 100 and the debt management and collection process 200 can be implemented on a computer system such as a special-purpose, special-programmed computer 700 illustrated in FIG. 7. Input user device(s) 710, such as a keyboard and/or mouse, are coupled to a bi-directional system bus 718. The input user device(s) 710 are for introducing user input to the computer system and communicating that user input to processor 713. The computer system of FIG. 7 generally also includes a non-transitory video memory 714, non-transitory main memory 715, and non-transitory mass storage 709, all coupled to bi-directional system bus 718 along with input user device(s) 710 and processor 713. The mass storage 709 may include both fixed and removable media, such as a hard drive, one or more CDs or DVDs, solid state memory including flash memory, and other available mass storage technology. Bus 718 may contain, for example, 32 of 64 address lines for addressing video memory 714 or main memory 715. The system bus 718 also includes, for example, an n-bit data bus for transferring DATA between and among the components, such as CPU 709, main memory 715, video memory 714 and mass storage 709, where “n” is, for example, 32 or 64. Alternatively, multiplex data/address lines may be used instead of separate data and address lines.

I/O device(s) 719 may provide connections to peripheral devices, such as a printer, and may also provide a direct connection to a remote server computer systems via a telephone link or to the Internet via an ISP. I/O device(s) 719 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 709, into main memory 715 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 713, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 715 is comprised of dynamic random access memory (DRAM). Video memory 714 is a dual-ported video random access memory. One port of the video memory 714 is coupled to video amplifier 716. The video amplifier 716 is used to drive the display 717. Video amplifier 716 is well known in the art and may be implemented by any suitable means. This circuitry converts pixel DATA stored in video memory 714 to a raster signal suitable for use by display 717. Display 717 is a type of monitor suitable for displaying graphic images.

The computer system described above is for purposes of example only. The debt management and collection system 100 and the debt management and collection process 200 may be implemented in any type of computer system or programming or processing environment. It is contemplated that the debt management and collection system 100 and the debt management and collection process 200 might be run on a stand-alone computer system, such as the one described above. The debt management and collection system 100 and the debt management and collection process 200 might also be run from a server computer systems system that can be accessed by a plurality of client computer systems interconnected over an intranet network. Finally, the debt management and collection system 100 and the debt management and collection process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method of guiding an AI engine for autonomous management and collection of debt, where one or more AI agents interacts with debtors through various communication channels and strategies, the method comprises:
executing code using one or more processors of a computer system to cause the computer system to perform operations comprising:
receiving input data on a recording platform, wherein the input data includes debtor information, invoice details, payment history, and previous interaction logs;
generating prompts to guide the AI engine for the management and collection of debt, wherein the prompts include one or more inputs received from the input data;
transferring the prompt to the AI engine configured to:
boot up a communication platform for initiating communication between an agent coordinator and the one or more AI agents;
analyze the input data via the agent coordinator by determining the stage of debt collection;
take action against the debtor by selecting the one or more AI agents by the agent coordinator and generate a communication strategy; and
communicate with the debtors by the corresponding AI agents using a predetermined communication strategy.

2. The method of claim 1 wherein the input data is received either by the user or fetched from an input database integrated within the recording platform.

3. The method of claim 1 wherein the input data is fetched from one or more sources, including company's financial database, CRM (customer relationship management) database, and past interaction record of debtor with the one or more AI agents.

4. The method of claim 1 wherein the communication platform is integrated with an application configured to automate the communication between the agent coordinator and one or more AI agents.

5. The method of claim 1 wherein the communication patterns are updated on a recurring basis by incorporating updated data collected on the input database, wherein the updated data includes customer response behavior, transaction success,
and communication frequency, allowing for continuous optimization of future customer communication strategies.

6. The method of claim 1, wherein the one or more AI agents are specialized personas to manage different stages of the autonomous debt management and collection, including one or more early-stage gentle reminders, mid-stage firm communication, late-stage negotiations, and legal escalations, with the agents adapting their communication strategies based on debtor profiles, historical data, and applicable laws.

7. The method of claim 1 wherein the AI agents include one or more investigator, credit controller voice, controller of ticket and email, and customer success manager.

8. The method of claim 1 wherein the communication channel includes at least one of email, phone call, text messaging, or in-application notification, and wherein the AI agent is configured to access an API to send physical letters through a third-party service, such as Lob.

9. The method of claim 1 wherein the event of a failed attempt of communication due to missing or incorrect contact information, the agent coordinator triggers one or more AI agents to retrieve the correct contact details, with the ticket being flagged for human intervention to check the contact information.

10. The method of claim 1 wherein the input database is updated with the received interactions with the debtors, wherein the interactions include actions taken by the AI agents, updated debtor profiles, communication logs, and payment status updates.

11. The method of claim 1 wherein Python codes are used for backend processing and SQL queries is used for data management, tracking of debt collection activities, and storage of debtor information.

12. The method of claim 1 wherein each AI agent operates within predefined legal boundaries and adheres to customer's policies regarding debt collection, ensuring compliance with applicable laws and ethical standards throughout the debt collection.

13. The method of claim 1 utilizes predefined thresholds for switching communication strategies and timing for escalations based on debtor responses.

14. A system of guiding an AI engine for autonomous management and collection of debt, where one or more AI agents interacts with debtors through various communication channels and strategies, the system comprises:
one or more processors of a computer system; and
one or more memories, coupled to the one or more processors, that store code and execution of the code by the one or more processors causes the computer system to perform operations comprising:
receiving input data on a recording platform, wherein the input data includes debtor information, invoice details, payment history, and previous interaction logs;
generating prompts to guide the AI engine for the management and collection of debt, wherein the prompts include one or more inputs received from the input data;
transferring the prompt to the AI engine configured to:
boot up a communication platform for initiating communication between an agent coordinator and the one or more AI agents;
analyze the input data via the agent coordinator by determining the stage of debt collection;
take action against the debtor by selecting the one or more AI agents by the agent coordinator and generate an appropriate communication strategy; and
communicate with the debtors by the corresponding AI agents using the appropriate communication strategies.

15. The system of claim 1 wherein the input data is received either by the user or fetched from an input database integrated within the recording platform.

16. The system of claim 1 wherein the input data is fetched from one or more sources, including company's financial database, CRM (customer relationship management) database, and past interaction record of debtor with the one or more AI agents.

17. The system of claim 1 wherein the communication platform is integrated with an application configured to automate the communication between the agent coordinator and one or more AI agents.

18. The system of claim 1 wherein the communication patterns are updated on a recurring basis by incorporating updated data collected on the input database, wherein the updated data includes customer response behavior, transaction success,
and communication frequency, allowing for continuous optimization of future customer communication strategies.

19. The system of claim 1, wherein the one or more AI agents are specialized personas to manage different stages of the autonomous debt management and collection, including one or more early-stage gentle reminders, mid-stage firm communication, late-stage negotiations, and legal escalations, with the agents adapting their communication strategies based on debtor profiles, historical data, and applicable laws.

20. The system of claim 1 wherein the AI agents include one or more investigator, credit controller voice, controller of ticket and email, and customer success manager.

21. The system of claim 1 wherein the communication channel includes at least one of email, phone call, text messaging, or in-application notification, and wherein the AI agent is configured to access an API to send physical letters through a third-party service, such as Lob.

22. The system of claim 1 wherein the event of a failed attempt of communication due to missing or incorrect contact information, the agent coordinator triggers one or more AI agents to retrieve the correct contact details, with the ticket being flagged for human intervention to check the contact information.

23. The system of claim 1 wherein the input database is updated with the received interactions with the debtors, wherein the interactions include actions taken by the AI agents, updated debtor profiles, communication logs, and payment status updates.

24. The system of claim 1 wherein Python codes are used for backend processing and SQL queries is used for data management, tracking of debt collection activities, and storage of debtor information.

25. The system of claim 1 wherein each AI agent operates within predefined legal boundaries and adheres to customer's policies regarding debt collection, ensuring compliance with applicable laws and ethical standards throughout the debt collection.

26. The system of claim 1 utilizes predefined thresholds for switching communication strategies and timing for escalations based on debtor responses.
